(19) United States
(12) Patent Application Publication
(10) Pub. No.: US 2012/0152925 A1
(43) Pub. Date: Jun. 21, 2012

(54) WELDING WIRE FEEDER WITH IMPROVED WIRE GUIDE

(75) Inventors: Mark R. Christopher, Neenah, WI (US); Nicholas A. Matiash, Oshkosh, WI (US)

(73) Assignee: Illinois Tool Works Inc., Glenview, IL (US)

(21) Appl. No.: 13/215,033

(22) Filed: Aug. 22, 2011

Related U.S. Application Data
(60) Provisional application No. 61/423,837, filed on Dec. 16, 2010.
(60) Provisional application No. 61/423,843, filed on Dec. 16, 2010.

(51) Int. Cl. B23K 9/00

(52) U.S. Cl. 219/137 R; 219/136

(57) ABSTRACT

A wire guide for use in a welding wire feeder is provided. The wire guide may consist of a pair of vertical pins mounted to a wire drive assembly to form a slit through which welding wire is guided toward a set of drive rolls. Another embodiment may consist of a generally conical piece with oblong entrance and exit ends mounted to the wire drive assembly.

### CROSS REFERENCE TO RELATED APPLICATIONS

This application is a Non-Provisional patent application of U.S. Provisional Patent Application No. 61/423,837, entitled “Obround/Elliptical Guide”, filed Dec. 16, 2010 and of U.S. Provisional Patent Application No. 61/423,843, entitled “Inlet Guide Pins”, filed Dec. 16, 2010, which are herein incorporated by reference.

### BACKGROUND

The invention relates generally to welding systems, and, more particularly, to a welding wire guide for use in a welding system.

Welding is a process that has increasingly become ubiquitous in various industries and applications. While such processes may be automated in certain contexts, a large number of applications continue to exist for manual welding operations. Such welding operations rely on a variety of types of equipment to ensure the supply of welding consumables (e.g., wire feed, shielding gas, etc.) is provided to the weld in an appropriate amount at the desired time. For example, metal inert gas (MIG) welding typically relies on a wire feeder to ensure a proper wire feed reaches a welding torch.

Such wire feeders facilitate the feeding of welding wire from a wire spool, through a pair of wire feed rolls, to the welding torch at the desired wire feed rate. Typically the wire is guided into the feed rolls with a tapered cylindrical tube fixed adjacent to the feed rolls. As the stack diameter of the wire wound on the spool changes due to wire use, the angle in the vertical plane at which the wire enters the cylindrical guide changes. In addition, the angle at which the wire enters the guide changes in the horizontal plane due to the helical unwind of the wire spool. Unfortunately, such an arrangement forces the wire into a fixed entry angle by sharply redirecting the wire as it enters the cylindrical guide. This leads to deformation of the wire surface and causes shavings from the wire to detach, which can ultimately clog welding torch liners and tips. Accordingly, there exists a need for a wire guide that overcomes these drawbacks.

### BRIEF DESCRIPTION

In an exemplary embodiment, a welding system includes a welding wire feeder including a wire spool, a pair of wire feed rolls configured to supply wire at a desired feed rate to a welding torch, and a wire guide configured to guide welding wire from the spool to the feed rolls. The wire guide is adapted to guide wire from whatever angle the wire comes off the spool in the horizontal and vertical planes without damaging the outer surface of the wire. The wire guide may consist of two vertical pins attached to the wire feeder between the spool and the feed rolls, positioned to form a slit through which welding wire is guided before entering the feed rolls.

In another embodiment, a welding system includes a welding wire feeder including a wire spool, a pair of wire feed rolls configured to supply wire to a welding torch, and a wire guide adapted to guide wire from whatever angle the wire comes off the spool in the horizontal and vertical planes without damaging the outer surface of the wire. The wire guide may have a generally conical shape and include an oblong entrance end and an oblong exit end and a tapered inner wall. The wire guide funnels the wire from an angle tangent to the spool to the fixed angle required by the feed rolls without damaging the wire.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary welding power supply coupled to a wire feeder in accordance with aspects of the present invention;

FIG. 2 is a block diagram illustrating exemplary functional components of the wire feeder of FIG. 1;

FIG. 3 is a side view of exemplary mechanical components of the wire feeder of FIG. 1;

FIG. 4 is a top view illustrating an exemplary pin wire guide in accordance with aspects of the present invention;

FIG. 5 illustrates an exemplary pin wire guide directing wire from a nearly full spool in accordance with aspects of the present invention;

FIG. 6 illustrates an exemplary pin wire guide directing wire from a less full spool in accordance with aspects of the present invention;

FIG. 7 illustrates an exemplary oblong wire guide directing wire from a spool in accordance with aspects of the present invention;

FIG. 8 is a side view of the exemplary oblong wire guide of FIG. 7; and

FIG. 9 is an entrance view of the exemplary oblong wire guide of FIG. 7.

### DETAILED DESCRIPTION

As described in detail below, embodiments of an improved wire guide for use in a welding wire feeder are provided. The wire guide is adapted to direct welding wire from a spool to the feed rolls of a wire drive assembly without causing damage to the outer surface of the wire. The wire guide may comprise an elongated slit, such as formed between two pins that direct wire coming off the spool at a range of angles in the vertical plane and in the horizontal plane. The two pins are attached vertically to the wire drive assembly, between the spool and the feed rolls. Welding wire may pass between the pins or make contact with the pins without damaging the outer surface of the wire because the angle of the wire is not sharply redirected. Still further, in certain embodiments, the wire guide may consist of a generally conical piece with an entrance end, an exit end, and a tapered inner wall. Welding wire is funneled through the conical guide to the feed rolls with a gradual redirection of the angle from which it exits the spool without causing damage to its outer surface.

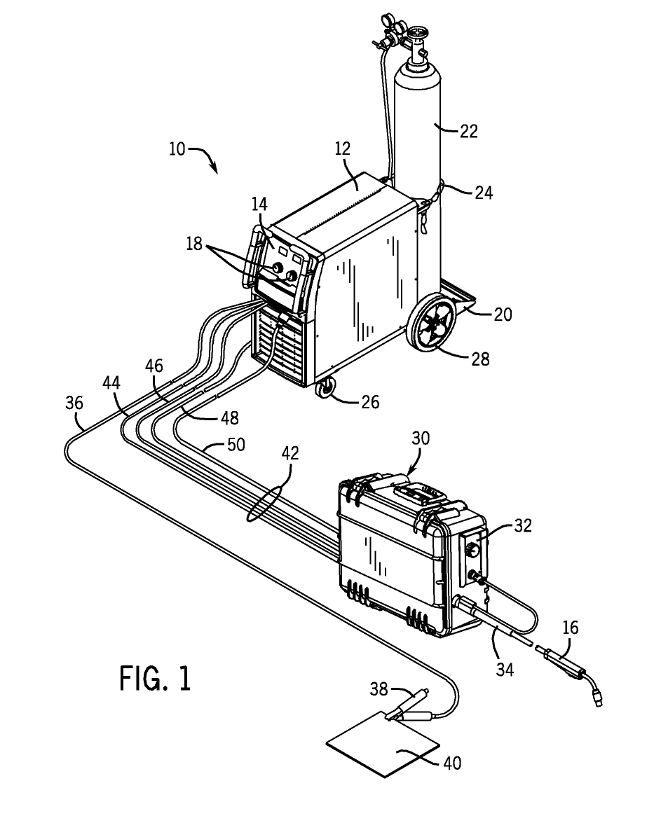

Turning now to the drawings, FIG. 1 illustrates an exemplary welding system 10 which powers, controls, and provides supplies to a welding operation. The welding system 10 includes a welder 12 having a control panel 14 through which a welding operator may control the supply of welding materials, such as gas flow, wire feed, and so forth, to a welding gun 16. To that end, the control panel 14 includes input or interface devices, such as control inputs 18 that the operator may use to adjust welding parameters (e.g., voltage, current, etc.). The welder 12 may also include a tray 20 mounted on a back of the welder 12 and configured to support a gas cylinder 22 held in place with a chain 24. The gas cylinder 22 is the source of the gas that supplies the welding gun 16. Furthermore, the welder 12 may be portable via a set of smaller front wheels 26 and a set of larger back wheels 28, which enable the operator to move the welder 12 to the location of the weld. It should be noted, however, that the present wire guide techniques may be used with any suitable type of welding system, typically MIG systems utilizing solid, flux cored or metal core wires fed by a wire feeder as described below. Moreover, the techniques may be used with both manual and automated welding systems.

The welding system 10 also includes a wire feeder 30 that provides welding wire to the welding gun 16 for use in the welding operation. The wire feeder 30 may include a control panel 32 that allows the user to set one or more wire feed parameters, such as wire feed speed. In presently contemplated embodiments, the wire feeder 30 houses a variety of internal components, such as a wire spool, a wire feed drive system, a wire guide, and so forth.

A variety of cables couple the components of the welding system 10 together and facilitate the supply of welding materials to the welding gun 16. A first cable 34 couples the welding gun 16 to the wire feeder 30. A second cable 36 couples the welder 12 to a work clamp 38 that connects to a workpiece 40 to complete the circuit between the welder 12 and the welding gun 16 during a welding operation. A bundle 42 of cables couples the welder 12 to the wire feeder 30 and provides weld materials for use in the welding operation. The bundle 42 includes a feeder power lead 44, a weld cable 46, a gas hose 48, and a control cable 50. Depending on the polarity of the welding process, the feeder power lead 44 connects to the same weld terminal as the cable 36. It should be noted that the bundle 42 of cables may not be bundled together in some embodiments. Conversely, in some systems some reduction in wiring may be realized, such as by communicating control and feedback signals over the welding power cable.

It should be noted that although the illustrated embodiments are described in the context of a constant voltage MIG welding process, the features of the invention may be utilized with a variety of other suitable welding systems and processes that utilize continuously fed wires.

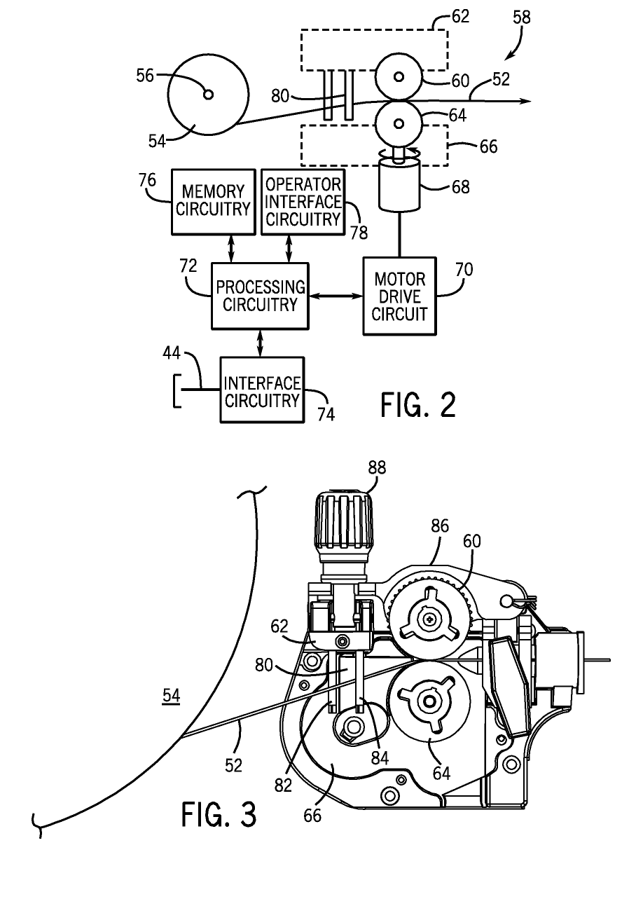

FIG. 2 is a block diagram illustrating internal components of the wire feeder 30. Welding wire 52 is supplied from a wire spool 54 that is mounted on a spool mount 56. The wire 52 is fed toward a welding operation by a wire drive assembly 58. The wire drive assembly includes an idle roller 60 mounted on an upper mounting surface 62, a drive roller 64 mounted on a lower mounting surface 66, and a motor drive 68 that turns the drive roller 64 in order to supply the wire at the desired wire feed rate to the welding operation.

A number of circuitry systems inside the wire feeder 30 facilitate the movement of wire 52 toward a welding operation at the desired wire feed rate. The motor drive circuit 70 causes the drive roller 64 to turn at the desired rate. Processing circuitry 72 communicates this turn rate to the motor drive circuit 70. Interface circuitry 74 connects directly to the feeder power lead 44 and supplies power to the processing circuitry 72. Memory circuitry 76 is connected to the processing circuitry 72, and operator interface circuitry 78 supplies the desired feed rate, which is input by the welding operator via the control panel, to the processing circuitry 72.

The wire feeder 30 features an elongated slit 80, which in the embodiment illustrated here is formed by two pins threaded into the upper mounting surface 62. The pins on either side of the elongated slit 80 guide the wire 52 from the spool 54 to the wire drive assembly 58 by defining a path the wire takes to become generally tangent to both the idle roller 60 and the drive roller 64.

FIG. 3 is a side view of certain of the functional components inside the wire feeder 30. The wire 52 is fed to a groove between the drive roller 64 and the idle roller 60, guided by the elongated slit 80 formed by two pins 82 and 84. The wire may touch one or both of the two pins or be suspended between the two pins, depending on the angle at which the wire comes off the spool 54 at a given moment. A pressure mechanism 86 urges the idle roller 60 towards the drive roller 64. This allows for more or less compression to be applied to the wire based on the size or material properties of the wire (e.g., steel versus aluminum welding wire). The pressure mechanism may be adjusted by a pressure adjustment knob 88.

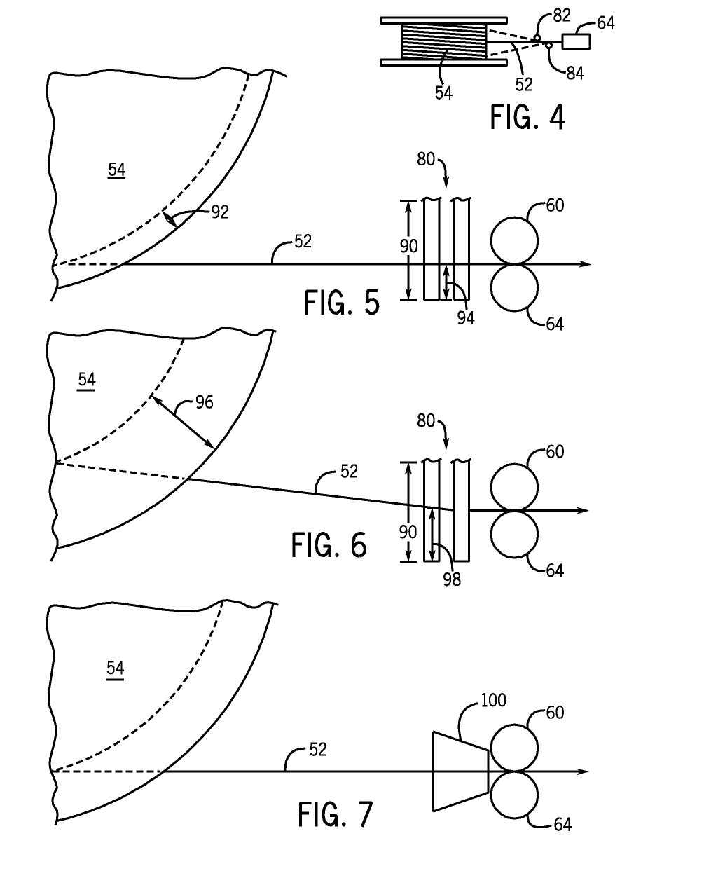

FIG. 4 is a top view of certain of these components in the wire feeder 30. As the wire 52 unwinds from the spool 54, the point of tangency of the wire to the spool (e.g., where the wire separates from the stack stored on the spool) moves axially back and forth across the width of the spool. Dotted lines outline an area that the wire may occupy as the spool unwinds. The wire is aligned with the drive roller 64 in order to properly move through the wire feeder, and the pins 82 and 84 guide the wire into alignment with the drive roller.

It should be noted that the pins 82 and 84 are displaced some distance away from the drive roller 64 in the direction of the spool 54, and that, in a presently contemplated embodiment, pin 82 is displaced further in this direction than pin 84. In this way, the wire travels a greater distance through this elongated guide than if the two pins were placed exactly side by side. Various arrangements of such elements may, however, be envisaged. There is also a displacement between both pins and the wire when the wire is perfectly aligned from the spool to the drive roller. This displacement allows wire to be guided gradually from the angle at which it exits the spool to proper alignment with the drive roller. Guiding the wire in this way avoids damaging the wire outer surface. Additionally, bearings (not shown) may be placed over the outside of the pins 82 and 84. Such bearings may rotate about the stationary pins, further reducing friction between the wire and pins. Similarly, the pins may be allowed to rotate themselves, as in the form of rollers.

FIG. 5 illustrates wire 52, from a nearly full spool 54, being fed through the elongated slit 80 to the feed rolls 60 and 64. The elongated slit is defined by two pins which each have a total length 90. There is a short radial distance 92 between the outer edge of the wire wrapped around the spool, which is indicated by a dashed line, and the outer edge of the spool. The wire slopes upward from its point of tangency with the spool to its point of tangency with the feed rolls. The wire passes through the slit 80 at a short distance 94 from the bottom of the slit to the wire.

FIG. 6 illustrates wire 52, from a less full spool 54, being fed through the elongated slit 80 and to the feed rolls 60 and 64. There is a long radial distance 96 between the outer edge of the wire wrapped around the spool and the outer edge of the spool. Unlike FIG. 5, FIG. 6 shows the wire sloping downward from its point of tangency with the spool to its point of tangency with the feed rolls. The wire passes through the slit 80 at a long distance 98 from the bottom of the slit to the wire.

As shown in FIG. 5 and FIG. 6, the elongated slit 80 helps guide wire 52 that exits the spool 54 at a range of angles in the vertical plane as the wire slopes towards the feed rolls 60 and 64. The pin embodiment of slit 80 accommodates this range of angles, leading to less wear and tear on the wire as it approaches the feed rolls.

FIG. 7 illustrates wire 52 being fed from the spool 54 and guided through an elongated, generally conical guide 100 to the feed rolls 60 and 64. The conical guide 100 functions in generally the same manner as the pins described above, and feeds the wire over a wide range of angles at which the wire exits the spool without damaging the wire.

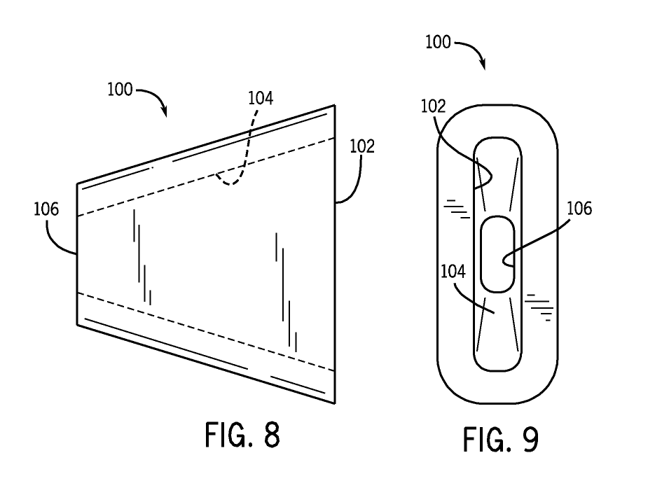

FIG. 8 is a detailed side view of an exemplary conical guide 100, showing an entrance end 102, an inner wall 104, and an exit end 106. The entrance end 102 has a greater height than the exit end 106, to guide wire from a full range of angles from spool to feed rolls, as illustrated in FIG. 7.

FIG. 9 is a detailed entrance view of the conical guide 100, showing the entrance end 102, exit end 106, and inner wall 104 leading between the two ends. The inner wall 104 narrows both vertically and horizontally from the entrance end to the exit end, to accommodate wire coming from the spool at a range of angles in the vertical and horizontal planes.

The height of the conical guide 100 may be greater than the width of the guide, from the entrance end 102 to the exit end 106. A greater height allows for the range of angles from which wire exits the spool 54 in the vertical plane. Although wire exits the spool at a range of angles in the horizontal plane, as shown in FIG. 4, this range is smaller than the vertical range of angles from which the wire exits the spool.

The conical guide 100 creates an oblong slit with rounded corners through which the welding wire 52 passes. The generally oblong shape accounts for the difference in range of angles in the vertical and horizontal plane from which the wire will be guided. The rounded, elliptical edges eliminate sharp corners so that the wire will not become pinned in an inside corner of the guide or rub against a sharp corner upon entering or exiting the guide, thereby avoiding damage to the wire. The conical guide 100 may also feature rounded outside edges at its entrance end 102 and exit end 106 to facilitate smoother entry and exit of the wire. Where desired, the guide may be allowed to pivot so as to better align with the entering wire.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding wire feed device, comprising:
a spool support configured to receive and support a spool of welding wire;
a wire drive assembly configured to draw wire from the spool and to drive the wire towards a welding application; and
a wire guide having two elongated, generally parallel guide surfaces spaced from one another to define an elongated slit through which the wire is guided from the spool to the wire drive assembly.

2. The device of claim 1, wherein the guide surfaces and the elongated slit are disposed generally vertically.

3. The device of claim 1, wherein the guide surfaces and the elongated slit are defined by a pair of elongated pins disposed between the spool support and the wire drive assembly.

4. The device of claim 1, wherein the guide surfaces and the elongated slit are defined by a generally conical guide disposed between the spool support and the wire drive assembly.

5. The device of claim 4, wherein the generally conical guide has an enlarged entrance end, a generally tapered inner wall, and an exit end of reduced dimensions as compared to the entrance end and comprising the generally parallel guide surfaces and the elongated slit.

6. The device of claim 5, wherein the entrance end defines an elongated slit wider than the elongated slit of the exit end.

7. The device of claim 5, wherein the elongated slit at the exit end is generally elliptical.

8. The device of claim 5, wherein the elongated slit at the exit end is generally oblong.

9. The device of claim 1, wherein the wire guide is supported by the wire drive assembly.

10. A welding wire feed device, comprising:
a wire guide having two elongated, generally parallel guide surfaces spaced from one another to define an elongated slit through which welding wire is guided from a spool to a wire drive assembly in operation.

11. The device of claim 10, wherein the guide surfaces and the elongated slit are disposed generally vertically.

12. The device of claim 10, wherein the guide surfaces and the elongated slit are defined by a pair of elongated pins configured to be disposed between the spool and the wire drive assembly.

13. The device of claim 10, wherein the guide surfaces and the elongated slit are defined by a generally conical guide configured to be disposed between the spool and the wire drive assembly.

14. The device of claim 13, wherein the generally conical guide has an enlarged entrance end, a generally tapered inner wall, and an exit end of reduced dimensions as compared to the entrance end and comprising the generally parallel guide surfaces and the elongated slit.

15. The device of claim 14, wherein the entrance end defines an elongated slit wider than the elongated slit of the exit end.

16. The device of claim 14, wherein the elongated slit at the exit end is generally elliptical.

17. The device of claim 14, wherein the elongated slit at the exit end is generally oblong.

18. A method for feeding welding wire to a welding application, comprising:
drawing wire from a spool via a wire drive assembly;
aligning the wire with wire drive rollers of the wire drive assembly via a wire guide having two elongated, generally parallel guide surfaces spaced from one another to define an elongated slit through which welding wire is guided from a spool to the drive rollers.

19. The method of claim 18, wherein the guide surfaces and the elongated slit are defined by a pair of elongated pins disposed between the spool and the wire drive assembly.

20. The method of claim 18, wherein the guide surfaces and the elongated slit are defined by a generally conical guide disposed between the spool and the wire drive assembly.
